(19) United States
(12) Patent Application Publication
(10) Pub. No.: US 2019/0394245 A1
(43) Pub. Date: Dec. 26, 2019

(54) Indication Of UE Voice Capabilities Using NAS Signaling In 5G Mobile Communications

(71) Applicant: MediaTek Singapore Pte. Ltd., Singapore (SG)

(72) Inventors: Marko Niemi, Oulu (FI); Kristian Lappalainen, Oulu (FI); Sami Jutila, Oulu (FI); Jani Manninen, Oulu (FI); Chien-Chun Huang-Fu, Hsinchu City (TW)

(21) Appl. No.: 16/452,334

(22) Filed: Jun. 25, 2019

Related U.S. Application Data
(60) Provisional application No. 62/689,347, filed on Jun. 25, 2018.

(51) Int. Cl. H04L 29/06

(52) U.S. Cl. CPC H04L 65/40; H04W 84/042; H04L 65/1016; H04L 65/1069

(57) ABSTRACT

Examples pertaining to indication of user equipment (UE) voice capabilities using non-access stratum (NAS) signaling in 5^{th} Generation (5G) mobile communications are described. A processor of an apparatus (e.g., a user equipment (UE)) transmits an indication of a voice domain preference in a 5^{th} Generation System (5GS) to a communication entity of a 5G mobile network. The processor then receives a voice service from the 5G mobile network responsive to the transmission of the indication.

### CROSS REFERENCE TO RELATED PATENT APPLICATION(S)

The present disclosure is part of a non-provisional application claiming the priority benefit of U.S. Patent Application No. 62/689,347, filed on 25 Jun. 2018. The content of aforementioned application is herein incorporated by reference in its entirety.

### TECHNICAL FIELD

The present disclosure is generally related to mobile communications and, more particularly, to indication of user equipment (UE) voice capabilities using non-access stratum (NAS) signaling in 5^{th} Generation (5G) mobile communications.

### BACKGROUND

Unless otherwise indicated herein, approaches described in this section are not prior art to the claims listed below and are not admitted as prior art by inclusion in this section.

Under the current 3^{rd} Generation Partnership Project (3GPP) specification, the 5^{th} Generation System (5GS) network feature support information element (IE) contains an Internet Protocol (IP) Multimedia Subsystem (IMS) voice over packet switching (VoPS) indication that informs a user equipment (UE) about support of IMS by a network. The network can indicate IMS voice over packet-switched (PS) session not supported, IMS voice over PS session supported over a 3GPP access, or IMS voice over PS session supported over a non-3GPP access. The UE can send its UE usage setting to the network in a registration request message to indicate whether the usage is voice centric or data centric. In Evolved Packet System (EPS), a UE can send its voice domain preference and usage setting to the network in attach and tracking area update request messages to indicate its preference.

However, under the 3GPP technical specification (TS) 24.301, a UE's usage setting for EPS is used to indicate the UE's preference for voice domain preference for Evolved Universal Terrestrial Radio Access Network (E-UTRAN). This could be interpreted as voice domain preference for E-UTRAN connected to EPS only. In particular, currently the UE can indicate its voice domain preference for E-UTRAN with a two-bit field as one of the following: circuit-switched (CS) voice only, IMS PS voice only, CS voice preferred with IMS PS voice as secondary, or IMS PS voice preferred with CS voice as secondary. On the other hand, in 5GS, there is not yet a mechanism defined for a UE to indicate its voice domain preference for 5GS/New Radio (NR) or its preference for the access type through which the UE is to use a voice service.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of an apparatus (e.g., UE) transmitting an indication of a voice domain preference in a 5GS to a communication entity of a 5G mobile network. The method may also involve the processor receiving a voice service from the 5G mobile network responsive to the transmitting.

In one aspect, a method may involve a processor of an apparatus (e.g., UE) receiving an indication related to support or preference for Single Radio Voice Call Continuity (SRVCC) from a communication entity of a 5G mobile network. The method may also involve the processor performing one or more operations responsive to the receiving.

In one aspect, an apparatus may include a transceiver and a processor coupled to the transceiver. The transceiver may, during operation, wirelessly communicate with a communication entity (e.g., gNB) of a 5G mobile network. The processor may, during operation, perform some operations including: (a) transmitting, via the transceiver, an indication of a voice domain preference in a 5GS to the communication entity of the 5G mobile network; and (b) receiving, via the transceiver, a voice service from the 5G mobile network responsive to the transmitting.

It is noteworthy that, although description provided herein may be in the context of certain radio access technologies, networks and network topologies such as 5G/NR, the proposed concepts, schemes and any variation(s)/derivative(s) thereof may be implemented in, for and by other types of radio access technologies, networks and network topologies such as, for example and without limitation, any advanced mobile communication systems developed in the future, any derivation of 5G/NR, Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of certain content of an example information element in accordance with an implementation of the present disclosure.

FIG. 3 is a diagram of certain content of an example information element in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

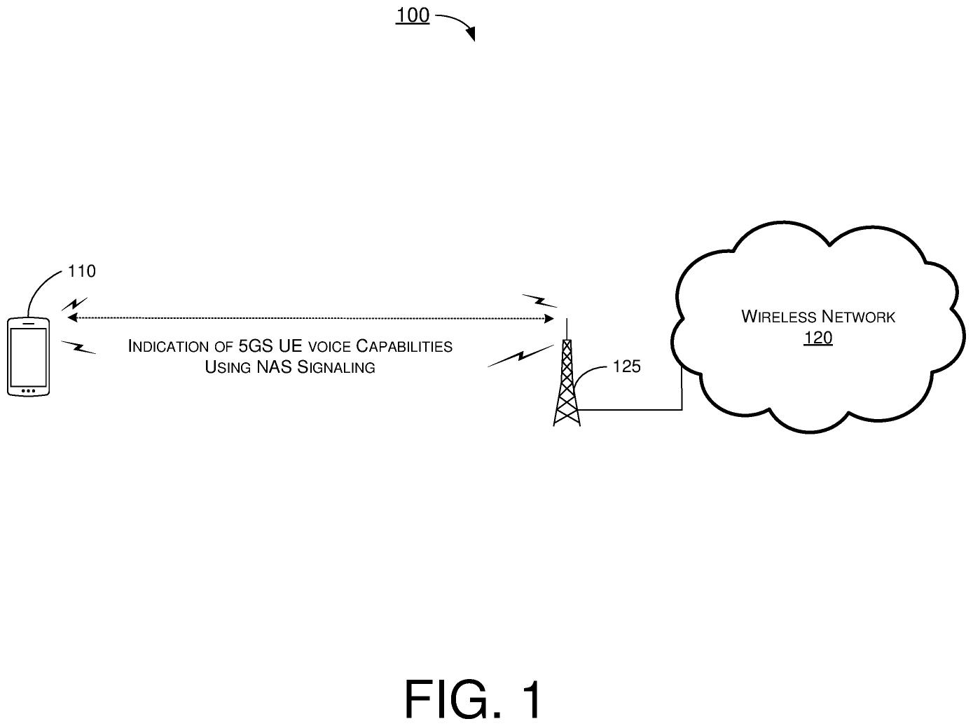

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network) via a base station 125 (e.g., a gNB or transmit-receive point (TRP)). In network environment 100, UE 110 and wireless network 120 may implement various schemes pertaining to indication of voice capabilities of UE 110 using NAS signaling in 5G mobile communications in accordance with the present disclosure. For instance, UE 110 may transmit to wireless network 120 an indication of voice capabilities of UE 110 (e.g., by extending a previously defined IE or provided in a new, to-be-defined IE). In response, UE 110 may receive a voice service from wireless network 120 as a result of transmitting the indication. The follow description of various solutions in accordance with the present disclosure is provided with reference to FIG. 1.

Under a proposed scheme in accordance with the present disclosure, UE 110 may indicate its voice domain preference in 5GS to wireless network 120 by either extending an existing IE that is previously defined in the 3GPP specification to include information pertaining to voice domain preference and capabilities of UE 110 or including the information pertaining to voice domain preference and capabilities in a new IE which is yet to be defined and specified in the 3GPP specification. Then, UE 110 may transmit the extended IE to wireless network 120. UE 110 may register with wireless network 120 over both a 3GPP access and a non-3GPP access. Accordingly, wireless network 120 may, based on information contained in the IE, perform one or more operations. For instance, wireless network 120 may allocate a most optimal network slice (e.g., registered Single-Network Slice Selection Assistance Information (NSSAI) or NSSAI) for UE 110 at registration. Additionally, or alternatively, wireless network 120 may refrain from handing over UE 110 to an access type that is not supported by UE 110. Additionally, or alternatively, wireless network 120 may select a Radio Access Technology (RAT)/Frequency Selection Priority (RFSP) index with respect to UE 110.

Under a proposed scheme in accordance with the present disclosure, UE 110 may extend an existing IE that is previously defined in the 3GPP specification in one of two approaches.

Under a first approach, UE 110 may, during 5G registration with wireless network 120, indicate its voice domain preference in 5GS (e.g., 3GPP, non-3GPP, EPS or CS). In some cases, UE 110 may indicate whether it prefers voice over Evolved Universal Terrestrial Radio Access (E-UTRA) or voice over NR. Under the first approach, the existing IE for “voice domain preference and UE's usage setting” as defined in 3GPP TS 24.008 may be extended for indication of voice domain preference of UE 110 in 5G/NR.

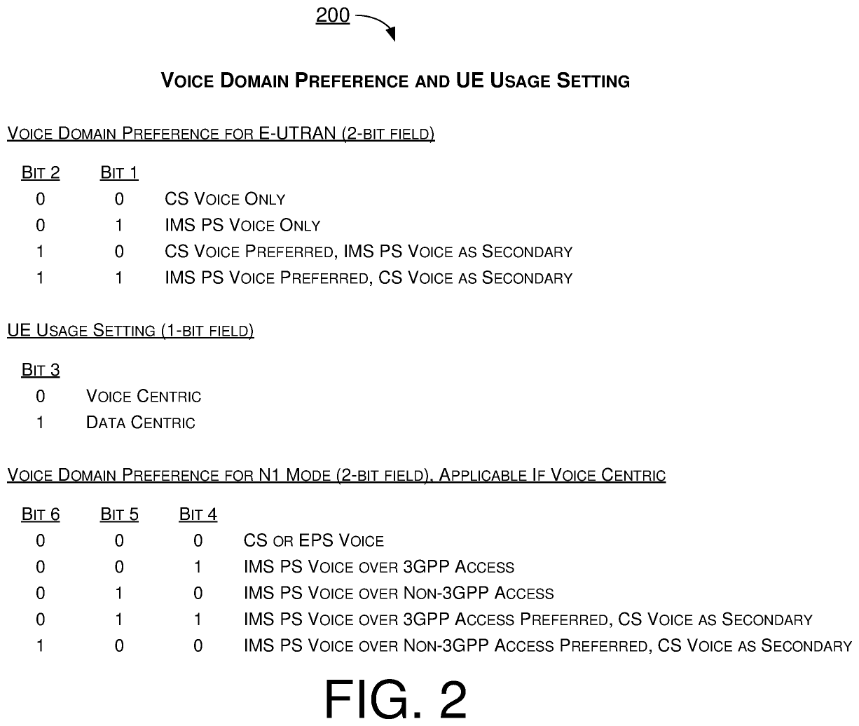

FIG. 2 illustrates certain content of an example information element 200 in accordance with an implementation of the present disclosure. Under the first approach, information element 200 may be an extended version of an IE for “voice domain preference and UE's usage setting” previously defined in 3GPP TS 24.008. Referring to FIG. 2, the two-bit field of bit 1 and bit 2 of one of a plurality of octets (e.g., octet 3) of IE 200 may be used to indicate the voice domain preference of UE 110 for E-UTRAN. For instance, bit 2 and bit 1 having values “00” may indicate CS voice only, bit 2 and bit 1 having values “01” may indicate IMS PS voice only, bit 2 and bit 1 having values “10” may indicate CS voice preferred with IMS PS voice as secondary, and bit 2 and bit 1 having values “11” may indicate IMS PS voice preferred with CS voice as secondary. Referring to FIG. 2, the one-bit field of bit 3 of the octet (e.g., octet 3) of IE 200 may be used to indicate whether usage setting of UE 110 is voice centric or data centric. For instance, bit 3 having a value “0” may indicate the usage setting of UE 110 being voice centric, and bit 3 having a value “1” may indicate the usage setting of UE 110 being data centric. Referring to FIG. 2, under the proposed scheme, the three-bit field of bit 6, bit 5 and bit 4 of the octet (e.g., octet 3) of IE 200 may be used to indicate voice domain preference for N1 mode in an event that use setting of UE 110 is voice centric. For instance, bit 6, bit 5 and bit 4 having values “000” may indicate a preference for CS or EPS voice, bit 6, bit 5 and bit 4 having values “001” may indicate a preference for IMS PS voice over a 3GPP access, bit 6, bit 5 and bit 4 having values “010” may indicate a preference for IMS PS voice over a non-3GPP access, bit 6, bit 5 and bit 4 having values “011” may indicate a preference for IMS PS voice over the 3GPP access with CS voice as secondary, and bit 6, bit 5 and bit 4 having values “100” may indicate a preference for IMS PS voice over the non-3GPP access with CS voice as secondary. Under the proposed schemes, values of other bits may be considered as reserved.

It is noteworthy that, although certain bits are shown to indicate corresponding information in the example shown in FIG. 2, in various implementations different bits may be used to indicate the same information. It is also noteworthy that, although a certain IE is shown to be extended to indicate voice domain preference and/or capabilities, in various implementations a different IE (or a new IE) may be utilized to carry such information. In other words, the scope of the first approach in accordance with the present disclosure is not limited to the description above or what is shown in FIG. 2.

Under a second approach, UE 110 may, during 5G registration with wireless network 120, indicate its voice domain preference in 5GS (e.g., 3GPP, non-3GPP, EPS or CS). In some cases, UE 110 may indicate whether it prefers voice over E-UTRA or voice over NR. Under the second approach, the existing IE for “UE's usage setting” as defined in 3GPP TS 24.501 may be extended for indication of voice domain preference of UE 110 in 5G/NR.

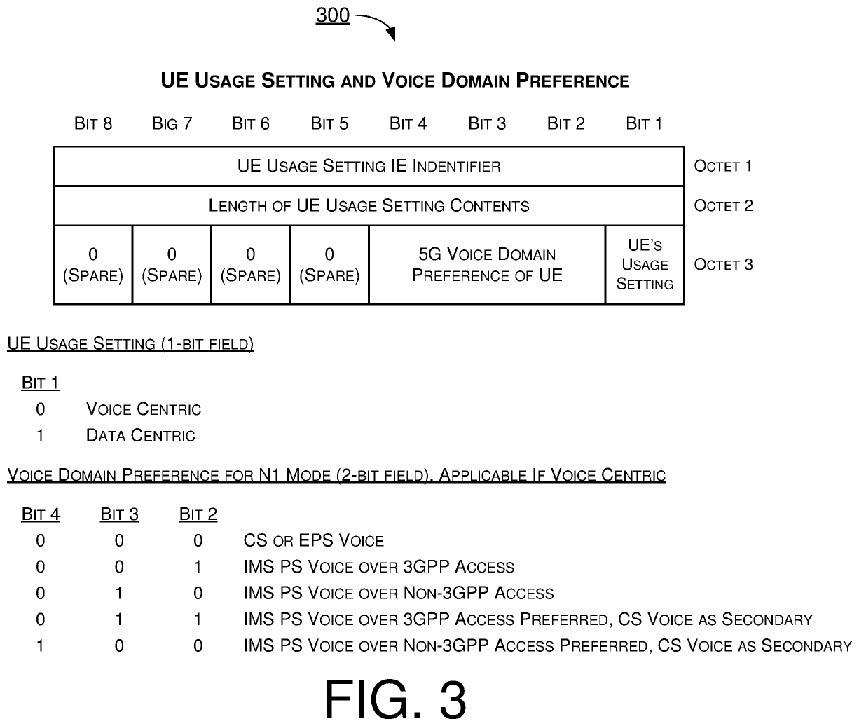

FIG. 3 illustrates certain content of an example information element 300 in accordance with an implementation of the present disclosure. Under the second approach, information element 300 may be an extended version of an IE for “UE's usage setting” previously defined in 3GPP TS 24.008 to also indicate 5G voice domain preference of UE 110. The IE 300 may be used by UE 110 to provide wireless network 120 with usage setting of UE 110 as defined in 3GPP TS 24.301 and 5G voice domain preference of UE 110. Accordingly, wireless network 120 may use the usage setting of UE 110 to select the RFSP index. In addition, wireless network 120 may use the 5G voice domain preference of UE 110 to select the RFSP index. IE 300 may be coded as shown in FIG. 3 and may be a type 4 IE with a length of three octets.

Referring to FIG. 3, IE 300 may include a plurality of octets. The first octet of the plurality of octets (e.g., Octet 1 shown in FIG. 3) may identify IE 300 as a UE usage setting IE, and a second octet of the plurality of octets (e.g., Octet 2 shown in FIG. 3) may indicate a length of UE usage setting contents. The third octet of the plurality of octets (e.g., Octet 3 shown in FIG. 3) may be utilized to indicate the usage setting and 5G voice domain preference of UE 110 under the proposed scheme in accordance with the present disclosure.

Referring to FIG. 3, the one-bit field of bit 1 of Octet 3 of IE 300 may be used to indicate whether usage setting of UE 110 is voice centric or data centric. For instance, bit 1 having a value “0” may indicate the usage setting of UE 110 being voice centric, and bit 1 having a value “1” may indicate the usage setting of UE 110 being data centric. Referring to FIG. 3, under the proposed scheme, the three-bit field of bit 4, bit 3 and bit 2 of Octet 3 of IE 300 may be used to indicate voice domain preference for N1 mode in an event that use setting of UE 110 is voice centric. For instance, bit 4, bit 3 and bit 2 having values “000” may indicate a preference for CS or EPS voice, bit 4, bit 3 and bit 2 having values “001” may indicate a preference for IMS PS voice over a 3GPP access, bit 4, bit 3 and bit 2 having values “010” may indicate a preference for IMS PS voice over a non-3GPP access, bit 4, bit 3 and bit 2 having values “011” may indicate a preference for IMS PS voice over the 3GPP access with CS voice as secondary, and bit 4, bit 3 and bit 2 having values “100” may indicate a preference for IMS PS voice over the non-3GPP access with CS voice as secondary. Under the proposed schemes, values of other bits may be considered as reserved. Moreover, all other bits in the octet (e.g., octet 3) may be spare and may be coded with value “0.”

It is noteworthy that, although certain bits are shown to indicate corresponding information in the example shown in FIG. 3, in various implementations different bits may be used to indicate the same information. It is also noteworthy that, although a certain IE is shown to be extended to indicate voice domain preference and/or capabilities, in various implementations a different IE (or a new IE) may be utilized to carry such information. In other words, the scope of the second approach in accordance with the present disclosure is not limited to the description above or what is shown in FIG. 3.

In an event that both UE 110, which is 5G capable, and wireless network 120 can support any voice solutions (e.g., voice over a 3GPP access in 5GS, voice over a non-3GPP access in 5GS, voice over E-UTRA (EPS) and CS voice (e.g., 2^{nd} Generation (2G)/3^{rd} Generation (3G)), voice services may preferably be routed over certain access(s). For example, due to the type of subscription of voice services for UE 110 or operator preference (e.g., as part of traffic overload control), there may be preference in routing voice services over certain access(s) for UE 110. Under a proposed scheme in accordance with the present disclosure, the voice domain preference of the 5G-capable UE 110 may be stored in wireless network 120 and provided to UE 110. Moreover, the information from wireless network 120 regarding voice domain preference may supersede or otherwise replace any pre-configured information regarding voice domain preference stored in UE 110. In addition, UE 110 may further provide this up-to-date information to a serving network (e.g., in a subsequent registration as described above with respect to the first and second approaches).

Under current 3GPP specification, between UE 110 and wireless network 120, it is UE 110 that provides information regarding capabilities with respect to 5G Single Radio Voice Call Continuity (SRVCC) to wireless network 120 regarding, for example, CS calls. However, without confirmation from wireless network 120 whether 5G SRVCC is supported by wireless network 120 for UE 110, there might be an issue with voice calls for UE 110.

Under a proposed scheme in accordance with the present disclosure, wireless network 120 may indicate to the 5G-capable UE 110 the voice domain preference and/or capabilities, as well as 5G SRVCC support, of wireless network 120. This indication from wireless network 120 to UE 110 may be based on the capabilities of both UE 110 and wireless network 120 or based solely on the capabilities of wireless network 120. For instance, wireless network 120 may provide an indication to UE 110 regarding support for 5G SRVCC by wireless network 120 in an event that both UE 110 and wireless network 120 support 5G SRVCC. Upon receipt of the indication from wireless network 120, UE 110 may behave accordingly. For instance, in an event that 5G SRVCC (e.g., voice call continuity from 5G PS domain to 2G/3G CS domain) cannot be performed, UE 110 may not need to perform cell measurement for 2G/3G cells during a voice call established in 5GS.

Thus, with the extension of IE as described above, the voice domain preference of UE 110 may be modified by wireless network 120 and then provided to UE 110. Moreover, wireless network 120 may indicate to UE 110 that 5G SRVCC is supported by wireless network 120. Correspondingly, UE 110 may, based on the indication that 5G SRVCC is supported by wireless network 120, perform one or more operations such as, for example: (1) determining whether or not to perform cell measurement for certain type of access, and (2) determining not to performing cell measurement for 2G/3G cells during a voice call that is started/established in 5GS (in an event that wireless network 120 does not support 5G SRVCC).

### Illustrative Implementations

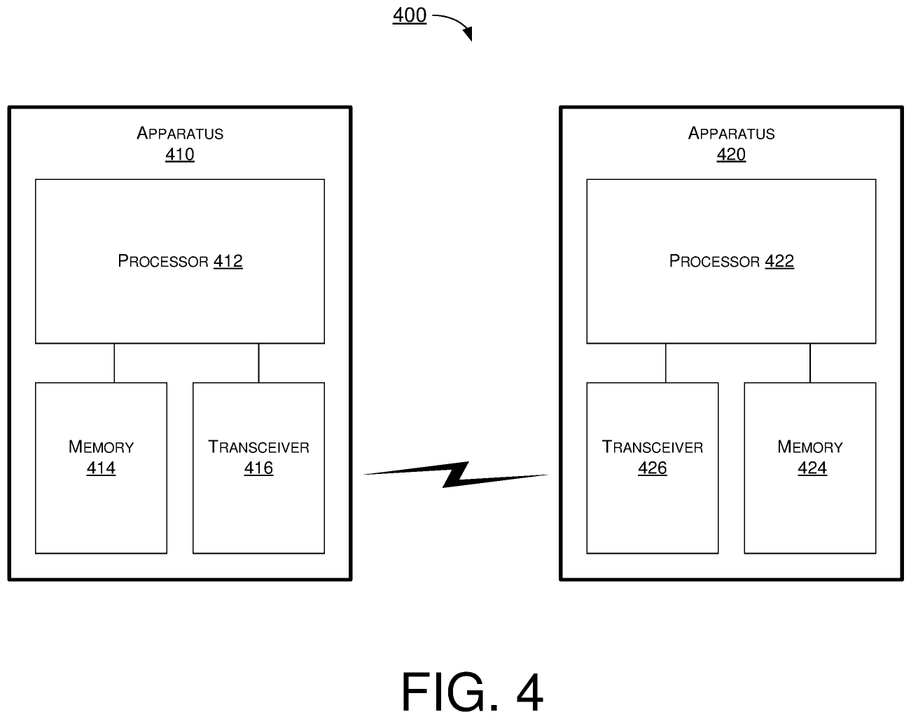

FIG. 4 illustrates an example system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to indication of UE voice capabilities using NAS signaling in 5G mobile communications, including the various schemes described above with respect to various proposed designs, concepts, schemes, systems and methods described above, including network environment 100, as well as processes 300, 400 and 500 described below.

Each of apparatus 410 and apparatus 420 may be a part of an electronic apparatus, which may be a network apparatus or a UE (e.g., UE 110), such as a portable or mobile apparatus, a wearable apparatus, a wireless communication apparatus or a computing apparatus. For instance, each of apparatus 410 and apparatus 420 may be implemented in a smartphone, a smart watch, a personal digital assistant, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an eNodeB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to indication of UE voice capabilities using NAS signaling in 5G mobile communications in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE, and apparatus 420, as a base station of a serving cell of a wireless network (e.g., 5G/NR mobile network), is provided below. It is noteworthy that, although the example implementations described below are provided in the context of a UE, the same may be implemented in and performed by a base station. Thus, although the following description of example implementations pertains to apparatus 410 as a UE (e.g., UE 110), the same is also applicable to apparatus 420 as a network node or base station such as a gNB, TRP or eNodeB (e.g., network node 125) of a wireless network (e.g., wireless network 120) such as a 5G NR mobile network.

Under a proposed scheme for indication of UE voice capabilities using NAS signaling in 5G mobile communications in accordance with the present disclosure, processor 412 of apparatus 410 may transmit, via transceiver 416, an indication of a voice domain preference in a 5GS to a communication entity (e.g., apparatus 420 as network node 125) of a 5G mobile network (e.g., wireless network 120). Moreover, processor 412 may receive, via transceiver 416, a voice service from the 5G mobile network (e.g., via apparatus 420) responsive to the transmitting.

In some implementations, in transmitting the indication of the voice domain preference in the 5GS, processor 412 may indicate the voice domain preference in the 5GS via NAS signaling during registration with the 5G mobile network.

In some implementations, the indication of the voice domain preference in the 5GS may include an indication of a preference of receiving the voice service via a 3GPP access, a non-3GPP access, an EPS, or CS.

In some implementations, the indication of the voice domain preference in the 5GS may include an indication of a preference of receiving the voice service over E-UTRA or NR.

In some implementations (e.g., under the first approach as described above and shown in FIG. 2), the indication of the voice domain preference in the 5GS may be included in an IE previously defined according to a 3GPP specification for voice domain preference and UE usage setting of apparatus 410. In some implementations, the indication of the voice domain preference in the 5GS may be included in one of a plurality of octets of the IE, such that: (a) bits 1 and 2 of the one of the plurality of octets may indicate the voice domain preference for E-UTRA, (b) bit 3 of the one of the plurality of octets may indicate the UE usage setting as being either voice centric or data centric, and (c) responsive to bit 3 indicating the UE usage setting as being voice centric, bits 4, 5 and 6 of the one of the plurality of octets may indicate the voice domain preference for N1 mode. In some implementations, the bits 4, 5 and 6 of the one of the plurality of octets may indicate preference for one of the following: CS or EPS voice, IMS PS voice over a 3GPP access, IMS PS voice over a non-3GPP access, IMS PS voice over the 3GPP access preferred with CS voice as secondary, and IMS PS voice over the non-3GPP access preferred with CS voice as secondary.

In some implementations (e.g., under the second approach as described above and shown in FIG. 3), the indication of the voice domain preference in the 5GS may be included in an IE previously defined according to a 3GPP specification for UE usage setting of apparatus 410. In some implementations, the indication of the voice domain preference in the 5GS may be included in a third octet of a plurality of octets of the IE. In such cases, a first octet of the plurality of octets may identify the IE as a UE usage setting IE, and a second octet of the plurality of octets may indicate a length of UE usage setting contents, such that: (a) bit 1 of the third octet may indicate the UE usage setting as being either voice centric or data centric, (b) responsive to bit 1 indicating the UE usage setting as being voice centric, bits 2, 3 and 4 of the third octet may indicate the voice domain preference for N1 mode. In some implementations, the bits 2, 3 and 4 of the third octet may indicate preference for one of the following: CS or EPS voice, IMS PS voice over a 3GPP access, IMS PS voice over a non-3GPP access, IMS PS voice over the 3GPP access preferred with CS voice as secondary, and IMS PS voice over the non-3GPP access preferred with CS voice as secondary.

In some implementations, prior to the transmitting, processor 412 may receive, via transceiver 416, information of the voice domain preference from the 5G mobile network (e.g., via apparatus 420) or another mobile network. Correspondingly, processor 412 may replace pre-configured information (e.g., stored in memory 414) about the voice domain preference with the received information.

Under another proposed scheme for indication of UE voice capabilities using NAS signaling in 5G mobile communications in accordance with the present disclosure, processor 412 may receive, via transceiver 416, an indication related to support or preference for Single Radio Voice Call Continuity (SRVCC) from a communication entity (e.g., apparatus 420) of a 5G mobile network (e.g., wireless network 120). In response to receiving the indication, processor 412 may perform one or more operations accordingly. For instance, processor 412 may determine whether to perform a cell measurement for a type of access. Alternatively, or additionally, processor 412 may determine not to performing a cell measurement for 2G and 3G cells during a voice call that is established in a 5GS in an event that SRVCC is not supported by the 5G mobile network.

In some implementations, the indication may be received during registration with the communication entity of the 5G mobile network.

In some implementations, the indication may be provided based on capabilities of both the 5G mobile network and the apparatus or solely based on capabilities of the 5G mobile network.

### Illustrative Processes

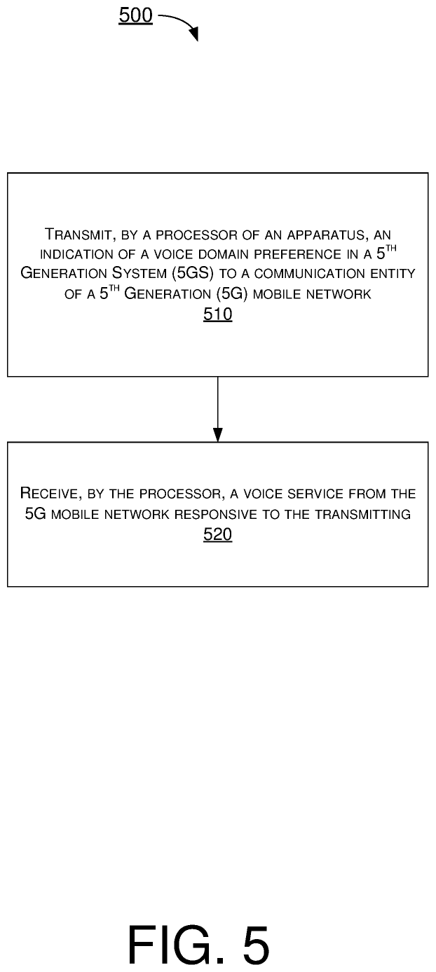

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to FIG. 1˜FIG. 4. More specifically, process 500 may represent an aspect of the proposed concepts and schemes pertaining to indication of UE voice capabilities using NAS signaling in 5G mobile communications. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a communication entity such as a network node or base station (e.g., network node 125) of a wireless network (e.g., wireless network 120). Process 500 may begin at block 510.

At 510, process 500 may involve processor 412 of apparatus 410 transmitting, via transceiver 416, an indication of a voice domain preference in a 5GS to a communication entity (e.g., apparatus 420 as network node 125) of a 5G mobile network (e.g., wireless network 120). Process 500 may proceed from 510 to 520.

At 520, process 500 may involve processor 412 receiving, via transceiver 416, a voice service from the 5G mobile network (e.g., via apparatus 420) responsive to the transmitting.

In some implementations, in transmitting the indication of the voice domain preference in the 5GS, process 500 may involve processor 412 indicating the voice domain preference in the 5GS via NAS signaling during registration with the 5G mobile network.

In some implementations, the indication of the voice domain preference in the 5GS may include an indication of a preference of receiving the voice service via a 3GPP access, a non-3GPP access, an EPS, or CS.

In some implementations, the indication of the voice domain preference in the 5GS may include an indication of a preference of receiving the voice service over E-UTRA or NR.

In some implementations (e.g., under the first approach as described above and shown in FIG. 2), the indication of the voice domain preference in the 5GS may be included in an IE previously defined according to a 3GPP specification for voice domain preference and UE usage setting of apparatus 410. In some implementations, the indication of the voice domain preference in the 5GS may be included in one of a plurality of octets of the IE, such that: (a) bits 1 and 2 of the one of the plurality of octets may indicate the voice domain preference for E-UTRA, (b) bit 3 of the one of the plurality of octets may indicate the UE usage setting as being either voice centric or data centric, and (c) responsive to bit 3 indicating the UE usage setting as being voice centric, bits 4, 5 and 6 of the one of the plurality of octets may indicate the voice domain preference for N1 mode. In some implementations, the bits 4, 5 and 6 of the one of the plurality of octets may indicate preference for one of the following: CS or EPS voice, IMS PS voice over a 3GPP access, IMS PS voice over a non-3GPP access, IMS PS voice over the 3GPP access preferred with CS voice as secondary, and IMS PS voice over the non-3GPP access preferred with CS voice as secondary.

In some implementations (e.g., under the second approach as described above and shown in FIG. 3), the indication of the voice domain preference in the 5GS may be included in an IE previously defined according to a 3GPP specification for UE usage setting of apparatus 410. In some implementations, the indication of the voice domain preference in the 5GS may be included in a third octet of a plurality of octets of the IE. In such cases, a first octet of the plurality of octets may identify the IE as a UE usage setting IE, and a second octet of the plurality of octets may indicate a length of UE usage setting contents, such that: (a) bit 1 of the third octet may indicate the UE usage setting as being either voice centric or data centric, (b) responsive to bit 1 indicating the UE usage setting as being voice centric, bits 2, 3 and 4 of the third octet may indicate the voice domain preference for N1 mode. In some implementations, the bits 2, 3 and 4 of the third octet may indicate preference for one of the following: CS or EPS voice, IMS PS voice over a 3GPP access, IMS PS voice over a non-3GPP access, IMS PS voice over the 3GPP access preferred with CS voice as secondary, and IMS PS voice over the non-3GPP access preferred with CS voice as secondary.

In some implementations, prior to the transmitting, process 500 may involve processor 412 receiving, via transceiver 416, information of the voice domain preference from the 5G mobile network (e.g., via apparatus 420) or another mobile network. Moreover, process 500 may involve processor 412 replacing pre-configured information (e.g., stored in memory 414) about the voice domain preference with the received information.

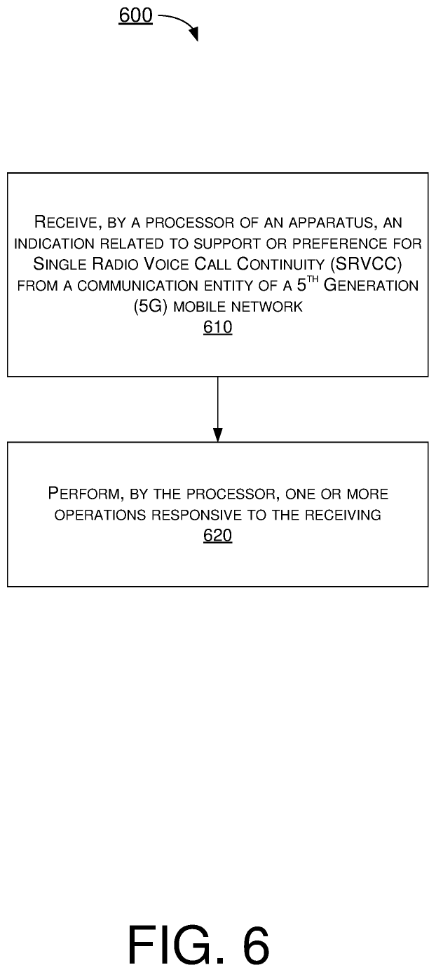

FIG. 6 illustrates an example process 600 in accordance with an implementation of the present disclosure. Process 600 may represent an aspect of implementing various proposed designs, concepts, schemes, systems and methods described above, whether partially or entirely, including those pertaining to FIG. 1˜FIG. 4. More specifically, process 600 may represent an aspect of the proposed concepts and schemes pertaining to indication of UE voice capabilities using NAS signaling in 5G mobile communications. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 410 and apparatus 420 as well as any variations thereof. Solely for illustrative purposes and without limiting the scope, process 600 is described below in the context of apparatus 410 as a UE (e.g., UE 110) and apparatus 420 as a communication entity such as a network node or base station (e.g., network node 125) of a wireless network (e.g., wireless network 120). Process 600 may begin at block 610.

At 610, process 600 may involve processor 412 receiving, via transceiver 416, an indication related to support or preference for SRVCC from a communication entity (e.g., apparatus 420) of a 5G mobile network (e.g., wireless network 120). Process 600 may proceed from 610 to 620.

At 620, process 600 may, in response to receiving the indication, involve processor 412 performing one or more operations accordingly. For instance, processor 412 may determine whether to perform a cell measurement for a type of access. Alternatively, or additionally, processor 412 may determine not to performing a cell measurement for 2G and 3G cells during a voice call that is established in a 5GS in an event that SRVCC is not supported by the 5G mobile network.

In some implementations, the indication may be received during registration with the communication entity of the 5G mobile network.

In some implementations, the indication may be provided based on capabilities of both the 5G mobile network and the apparatus or solely based on capabilities of the 5G mobile network.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, an indication of a voice domain preference in a 5^{th} Generation System (5GS) to a communication entity of a 5^{th} Generation (5G) mobile network; and
receiving, by the processor, a voice service from the 5G mobile network responsive to the transmitting.

2. The method of claim 1, wherein the transmitting of the indication of the voice domain preference in the 5GS comprises indicating the voice domain preference in the 5GS via non-access stratum (NAS) signaling during registration with the 5G mobile network.

3. The method of claim 1, wherein the indication of the voice domain preference in the 5GS comprises an indication of a preference of receiving the voice service via a 3^{rd}-Generation Partnership Project (3GPP) access, a non-3GPP access, an Evolved Packet System (EPS), or circuit switching (CS).

4. The method of claim 1, wherein the indication of the voice domain preference in the 5GS comprises an indication of a preference of receiving the voice service over Evolved Universal Terrestrial Radio Access (E-UTRA) or New Radio (NR).

5. The method of claim 1, wherein the indication of the voice domain preference in the 5GS is included in an information element (IE) previously defined according to a 3^{rd}-Generation Partnership Project (3GPP) specification for voice domain preference and user equipment (UE) usage setting.

6. The method of claim 5, wherein the indication of the voice domain preference in the 5GS is included in one of a plurality of octets of the IE, and wherein:
bits 1 and 2 of the one of the plurality of octets indicate the voice domain preference for Evolved Universal Terrestrial Radio Access (E-UTRA),
bit 3 of the one of the plurality of octets indicates the UE usage setting as being either voice centric or data centric, and
responsive to bit 3 indicating the UE usage setting as being voice centric, bits 4, 5 and 6 of the one of the plurality of octets indicate the voice domain preference for N1 mode.

7. The method of claim 6, wherein the bits 4, 5 and 6 of the one of the plurality of octets indicate preference for one of:
circuit-switched (CS) or Evolved Packet System (EPS) voice,
Internet Protocol (IP) Multimedia Subsystem (IMS) packet-switched (PS) voice over a 3GPP access,
IMS PS voice over a non-3GPP access,
IMS PS voice over the 3GPP access preferred with CS voice as secondary, and
IMS PS voice over the non-3GPP access preferred with CS voice as secondary.

8. The method of claim 1, wherein the indication of the voice domain preference in the 5GS is included in an information element (IE) previously defined according to a 3rd-Generation Partnership Project (3GPP) specification for user equipment (UE) usage setting.

9. The method of claim 8, wherein the indication of the voice domain preference in the 5GS is included in a third octet of a plurality of octets of the IE, wherein a first octet of the plurality of octets identifies the IE as a UE usage setting IE, wherein a second octet of the plurality of octets indicates a length of UE usage setting contents, and wherein:
bit 1 of the third octet indicates the UE usage setting as being either voice centric or data centric,
responsive to bit 1 indicating the UE usage setting as being voice centric, bits 2, 3 and 4 of the third octet indicate the voice domain preference for N1 mode.

10. The method of claim 9, wherein the bits 2, 3 and 4 of the third octet indicate preference for one of:
circuit-switched (CS) or Evolved Packet System (EPS) voice,
Internet Protocol (IP) Multimedia Subsystem (IMS) packet-switched (PS) voice over a 3GPP access,
IMS PS voice over a non-3GPP access,
IMS PS voice over the 3GPP access preferred with CS voice as secondary, and
IMS PS voice over the non-3GPP access preferred with CS voice as secondary.

11. The method of claim 1, further comprising:
prior to the transmitting:
receiving, by the processor, information of the voice domain preference from the 5G mobile network or another mobile network; and
replacing, by the processor, pre-configured information about the voice domain preference with the received information.

12. A method, comprising:
receiving, by a processor of an apparatus, an indication related to support or preference for Single Radio Voice Call Continuity (SRVCC) from a communication entity of a 5th Generation (5G) mobile network; and
performing, by the processor, one or more operations responsive to the receiving.

13. The method of claim 12, wherein the indication is received during registration with the communication entity of the 5G mobile network.

14. The method of claim 12, wherein the indication is provided based on capabilities of both the 5G mobile network and the apparatus or solely based on capabilities of the 5G mobile network.

15. The method of claim 12, wherein the performing of the one or more operations comprises performing at least one of:
determining whether to perform a cell measurement for a type of access; and
determining not to performing a cell measurement for 2^{nd} Generation (2G) and 3^{rd} Generation (3G) cells during a voice call that is established in a 5^{th} Generation System (5GS) in an event that SRVCC is not supported by the 5G mobile network.

16. An apparatus, comprising:
a transceiver which, during operation, wirelessly communicates with a communication entity of a 5^{th} Generation (5G) mobile network; and
a processor coupled to the transceiver such that, during operation, the processor performs operations comprising:
transmitting, via the transceiver, an indication of a voice domain preference in a 5^{th} Generation System (5GS) to the communication entity of the 5G mobile network; and
receiving, via the transceiver, a voice service from the 5G mobile network responsive to the transmitting.

17. The apparatus of claim 16, wherein the indication of the voice domain preference in the 5GS is included in an information element (IE) previously defined according to a 3^{rd}-Generation Partnership Project (3GPP) specification for voice domain preference and user equipment (UE) usage setting, wherein the indication of the voice domain preference in the 5GS is included in one of a plurality of octets of the IE, and wherein:
bits 1 and 2 of the one of the plurality of octets indicate the voice domain preference for Evolved Universal Terrestrial Radio Access (E-UTRA),
bit 3 of the one of the plurality of octets indicates the UE usage setting as being either voice centric or data centric, and
responsive to bit 3 indicating the UE usage setting as being voice centric, bits 4, 5 and 6 of the one of the plurality of octets indicate the voice domain preference for N1 mode.

18. The apparatus of claim 17, wherein the bits 4, 5 and 6 of the one of the plurality of octets indicate preference for one of:
circuit-switched (CS) or Evolved Packet System (EPS) voice,
Internet Protocol (IP) Multimedia Subsystem (IMS) packet-switched (PS) voice over a 3GPP access,
IMS PS voice over a non-3GPP access,
IMS PS voice over the 3GPP access preferred with CS voice as secondary, and
IMS PS voice over the non-3GPP access preferred with CS voice as secondary.

19. The apparatus of claim 16, wherein the indication of the voice domain preference in the 5GS is included in an information element (IE) previously defined according to a 3^{rd}-Generation Partnership Project (3GPP) specification for user equipment (UE) usage setting, wherein the indication of the voice domain preference in the 5GS is included in a third octet of a plurality of octets of the IE, wherein a first octet of the plurality of octets identifies the IE as a UE usage setting IE, wherein a second octet of the plurality of octets indicates a length of UE usage setting contents, and wherein:
bit 1 of the third octet indicates the UE usage setting as being either voice centric or data centric,
responsive to bit 1 indicating the UE usage setting as being voice centric, bits 2, 3 and 4 of the third octet indicate the voice domain preference for N1 mode.

20. The apparatus of claim 19, wherein the bits 2, 3 and 4 of the third octet indicate preference for one of:
circuit-switched (CS) or Evolved Packet System (EPS) voice,
Internet Protocol (IP) Multimedia Subsystem (IMS) packet-switched (PS) voice over a 3GPP access,
IMS PS voice over a non-3GPP access,
IMS PS voice over the 3GPP access preferred with CS voice as secondary, and
IMS PS voice over the non-3GPP access preferred with CS voice as secondary.
